(19) United States
(12) Patent Application Publication
(10) Pub. No.: US 2011/0216550 A1
(43) Pub. Date: Sep. 8, 2011

(54) VEHICLE LIGHT

(76) Inventors: Teruo KOIKE, Tokyo (JP); Ji Hao Liang, Tokyo (JP)

(21) Appl. No.: 13/039,305

(22) Filed: Mar. 2, 2011

(30) Foreign Application Priority Data
Mar. 2, 2010 (JP) 2010-045320
Mar. 18, 2010 (JP) 2010-062585

(51) Int. Cl. F21S 8/10

(52) U.S. Cl. 362/519

(57) ABSTRACT

A vehicle light can prevent or suppress uneven luminance chromaticity or uneven intensity distribution of light caused by reflection of blue laser beams emitted from a laser light source and reflected by the surface of a metal plate located around fluorescent material. The vehicle light can include a metal plate, a fluorescent material provided on a surface of the metal plate. The fluorescent material can serve as a light source for emitting light beams as a result of excitation by a blue laser beam. A laser light source can be configured to emit the blue laser beam to be incident on the fluorescent material. A reflection suppressing member can be provided to cover the surface of the metal plate around the fluorescent material and can be configured to suppress the reflection of the blue laser beam emitted by the laser light source.

This application claims the priority benefit under 35 U.S.C. §119 of Japanese Patent Applications No. 2010-045320 filed on Mar. 2, 2010 and No. 2010-062585 filed on Mar. 18, 2010, which are hereby incorporated in their entirety by reference.

### TECHNICAL FIELD

The presently disclosed subject matter relates to a vehicle light, and in particular, to a vehicle light utilizing a light source in which a blue laser beam and a fluorescent material that can emit light by being excited by the blue laser beam are used.

### BACKGROUND ART

In the conventional technical field relating to vehicle lights, a brighter light source has been desired to illuminate distant areas with high intensity light beams at night. One example is described in Japanese Patent Application Laid-Open No. 2005-150041 (corresponding to U.S. Pat. No. 7,165,871).

The present inventors have focused on the point in which the brightness (or intensity) of a fluorescent material (for example, YAG fluorescent material) excited by a blue laser beam to emit light beams is higher than that of an HID lamp (and also white LED, see FIG. 1), and have experimentally produced a light source to be used in a vehicle lamp utilizing the fluorescent material.

FIG. 2 is a diagram illustrating the configuration of a light source 200 for use in a vehicle light experimentally produced by the present inventors.

As shown in FIG. 2, the light source 200 can include a light emission portion 210, a laser optical system 220, and other components.

The light emission portion 210 can include a metal plate 211, a fluorescent material 212, and other components.

The metal plate 211 can be, for example, an aluminum plate with the size of 1.5 mm in length, 7.5 mm in width, and 2 mm in thickness. A fluorescent material 212 can be applied onto the surface of the metal plate 211 with the size of 0.5 mm in length, 2.5 mm in width and 0.1 mm in thickness. It should be noted that the fluorescent material 212 can emit light when excited by blue light, such as a blue laser beam, and can be composed of YAG fluorescent material.

The laser optical system 220 can include a laser light source 221, a lens 222, and other components.

The laser light source 221 can be a light source for emitting a blue laser beam (radiation flux) to impinge on the fluorescent material 212. For example, the laser light source 221 can be a high power semiconductor laser device with the following specification:

Light emission size: 2 μM in length and 10 μM in width

Optical output: 2 W

Luminescent chromaticity: blue (440 nm)

Light directivity: Gaussian distribution (30° in a lateral direction and 60° in a longitudinal direction).

The lens 222 can be a lens for converging blue laser beams emitted from the laser light source 221 to be a size almost equal to that of the fluorescent material 212. For example, the lens 222 may be a convergent lens or a collimating lens. The lens 222 can be disposed in front of the laser light source 221.

In the above light source 200 as configured above, the blue laser beams emitted from the laser light source 221 can be converged by the action of the lens 222 to have a size equal to the size of the fluorescent material 212 (0.5 mm in length and 2.5 mm in width) and projected onto the fluorescent material 212 (see FIG. 2). The converged laser beams can excite the fluorescent material 212 to cause the fluorescent material 212 to emit light beams, thereby generating white light beams (see FIG. 3). It should be noted that in FIG. 3 the elliptic range represents the application range of the fluorescent material 212.

However, in the light source 200 of the vehicle light with the above configuration, if the size of the radiation flux from the laser optical system 220 becomes larger than the size of the fluorescent material 212 for some reason (or the blue laser beams from the laser optical system 200 are shifted with respect to the fluorescent material 212), the blue laser beams larger in size (or shifted) can impinge on the surface of the metal plate around the fluorescent material 212 (see FIG. 4) and be reflected by the same (see FIGS. 5, 6A, and 6B). Accordingly, this may cause uneven luminescent chromaticity as well as uneven intensity distribution. For example, as shown in FIG. 7 in addition to FIGS. 5, 6A, and 6B, the area around the light distribution pattern P including a bright/dark boundary line CL may be colored blue. It should be noted that FIGS. 6A and 6B are graphs showing a luminous intensity distribution of an area including the fluorescent material 212 and the metal plate 211 around the material 212 taken along line C-C and line D-D in FIG. 3, respectively.

Besides, when white light can be generated by the excitation of the fluorescent material 212, the fluorescent material 212 and the metal plate 211 irradiated with the high energy blue laser beams may rapidly be heated (to approx. 1000° C.) so that they are thermally expanded.

In the light source 200 with the above configuration, however, the fluorescent material 212 and the metal plate 211 may have different thermal expansion coefficients (for example, thermal expansion coefficient of YAG phosphor: 2.4 to 7.8, thermal expansion coefficient of aluminum: 24). Accordingly, when the turning-on and turning-off are repeated (namely, the temperature increase/decrease is repeated), interfacial peeling may disadvantageously occur.

### SUMMARY

The presently disclosed subject matter was devised in view of these and other problems and features and in association with the conventional art. According to an aspect of the presently disclosed subject matter, a vehicle light can prevent or suppress the uneven luminance chromaticity or uneven intensity distribution of light caused by the reflection of blue laser beams emitted from a laser light source and reflected by the surface of a metal plate around a fluorescent material.

According to another aspect of the presently disclosed subject matter, a vehicle light can prevent or suppress the occurrence of interfacial peeling caused by the difference of thermal expansion coefficient between a fluorescent material and a member to which the fluorescent material is disposed.

According to still another aspect of the presently disclosed subject matter, a vehicle light can include: a metal plate; a fluorescent material that is provided on a surface of the metal plate and can serve as a light source for emitting light beams as a result of excitation by a blue laser beam; a laser light source configured to emit the blue laser beam to be incident on the fluorescent material; and a reflection suppressing member that is provided to cover the surface of the metal plate around the fluorescent material and is configured to suppress the reflection of the blue laser beam emitted by the laser light source.

In the vehicle light with the above configuration, as the surface of the metal plate around the fluorescent material can be covered with the reflection suppressing member, even if the size of the radiation flux from the laser optical system becomes larger than the size of the fluorescent material for some reason (or the blue laser beams from the laser optical system are shifted with respect to the fluorescent material), the blue laser beams larger in size (or shifted) can impinge not on the surface of the metal plate around the fluorescent material but on the reflection suppressing member thereby suppressing the reflection therefrom. The vehicle light with this configuration can prevent or suppress the uneven luminance chromaticity or uneven intensity distribution of light caused by the reflection of blue laser beams emitted from the laser light source and reflected by the surface of the metal plate around the fluorescent material.

In the vehicle light with the above configuration, the reflection suppressing member can be formed from a carbon plate having an opening where the fluorescent material is to be disposed. In this configuration, the blue laser beams can impinge on the carbon plate without impinging on the metal plate around the fluorescent material, thereby suppressing the reflection therefrom. Accordingly, the vehicle light with this configuration can prevent or suppress the uneven luminance chromaticity or uneven intensity distribution of light caused by the reflection of blue laser beams emitted from the laser light source and reflected by the surface of the metal plate around the fluorescent material.

The vehicle light with the above configuration can further include an optical system configured to project an image of the fluorescent material as a light source image so as to form a low beam light distribution pattern or a high beam light distribution pattern.

In the vehicle light with the above configuration, the fluorescent material can be configured to include a side corresponding to a bright/dark boundary line of the low beam light distribution pattern or the high beam light distribution pattern, and the optical system can include a projection lens having a focus disposed at or near the side of the fluorescent material corresponding to the bright/dark boundary line, and can be disposed in front of the fluorescent material. This configuration can achieve a so-called direct projection type vehicle light utilizing a fluorescent material for emitting white light by the excitation by the blue laser beam irradiation so as to form the low beam light distribution pattern or the high beam light distribution pattern.

Alternatively, in the vehicle light with the previous configuration, the fluorescent material can be configured to include a side corresponding to a bright/dark boundary line of the low beam light distribution pattern or the high beam light distribution pattern, and the optical system can include a projection lens, a reflecting surface, and a light-shielding member disposed between the projection lens and the reflecting surface and having an upper edge, in which the reflecting surface can be a revolved elliptic reflecting surface having a first focus disposed at or near the side of the fluorescent material corresponding to the bright/dark boundary and a second focus disposed at or near the upper edge of the light-shielding member, and the projection lens can have a focus disposed at or near the upper edge of the light-shielding member. This configuration can achieve a so-called projector type vehicle light utilizing a fluorescent material for emitting white light by the excitation by the blue laser beam irradiation so as to form the low beam light distribution pattern or the high beam light distribution pattern.

Further alternatively, in the vehicle light with the previous configuration, the fluorescent material can be configured to include a side corresponding to a bright/dark boundary line of the low beam light distribution pattern or the high beam light distribution pattern, and the optical system can include a revolved parabolic reflecting surface having a focus disposed at or near the side of the fluorescent material corresponding to the bright/dark boundary line. This configuration can achieve a so-called reflective type (or parabola type) vehicle light utilizing a fluorescent material for emitting white light by the excitation by the blue laser beam irradiation so as to form the low beam light distribution pattern or the high beam light distribution pattern.

According to still further another aspect of the presently disclosed subject matter, a vehicle light can include: a structure including a fluorescent material that can serve as a light source for emitting light beams as a result of excitation by a laser beam, a mating member having a different thermal expansion coefficient from that of the fluorescent material, and a barium sulfate layer formed between the fluorescent material and the mating member; and a laser light source configured to emit the laser beam to be incident on the fluorescent material.

In the vehicle light with the above configuration, the barium sulfate layer formed between the fluorescent material and the mating member having a different thermal expansion coefficient from that of the fluorescent material can exert its buffer action, and it is possible to prevent or suppress the occurrence of interfacial peeling caused by the difference of thermal expansion coefficient between the fluorescent material and the member to which the fluorescent material is disposed.

In the vehicle light with the above configuration, the mating member can be formed from an AlN sintered body.

In the vehicle light with the above configuration, the barium sulfate layer formed between the fluorescent material and the AlN sintered body can exert its buffer action, and it is possible to prevent or suppress the occurrence of interfacial peeling caused by the difference of thermal expansion coefficient between the fluorescent material and the AlN sintered body.

The vehicle light with the above configuration can further include a heat dissipation member, to which the AlN sintered body can be eutectic bonded. The heat dissipation member eutectic bonded to the AlN sintered body can improve the heat dissipation effect in the vehicle light.

The vehicle light with the above configuration can further include an optical system configured to project an image of the fluorescent material as a light source image so as to form a low beam light distribution pattern or a high beam light distribution pattern.

In the vehicle light with the above configuration, the fluorescent material can be configured to include a side corresponding to a bright/dark boundary line of the low beam light distribution pattern or the high beam light distribution pattern, and the optical system can include a projection lens having a focus disposed at or near the side of the fluorescent material corresponding to the bright/dark boundary line, and can be disposed in front of the fluorescent material. This configuration can achieve a so-called direct projection type vehicle light utilizing a fluorescent material for emitting light by the excitation by the laser beam irradiation so as to form the low beam light distribution pattern or the high beam light distribution pattern.

Alternatively, in the vehicle light with the previous configuration, the fluorescent material can be configured to include a side corresponding to a bright/dark boundary line of the low beam light distribution pattern or the high beam light distribution pattern, and the optical system can include a projection lens, a reflecting surface, and a light-shielding member disposed between the projection lens and the reflecting surface and having an upper edge, in which the reflecting surface can be a revolved elliptic reflecting surface having a first focus disposed at or near (i.e., substantially at) the side of the fluorescent material corresponding to the bright/dark boundary and a second focus disposed at or near the upper edge of the light-shielding member, and the projection lens can have a focus disposed at or near the upper edge of the light-shielding member. This configuration can achieve a so-called projector type vehicle light utilizing a fluorescent material for emitting light by the excitation by the laser beam irradiation so as to form the low beam light distribution pattern or the high beam light distribution pattern.

Further alternatively, in the vehicle light with the previous configuration, the fluorescent material can be configured to include a side corresponding to a bright/dark boundary line of the low beam light distribution pattern or the high beam light distribution pattern, and the optical system can include a revolved parabolic reflecting surface having a focus disposed at or near the side of the fluorescent material corresponding to the bright/dark boundary line. This configuration can achieve a so-called reflective type (or parabola type) vehicle light utilizing a fluorescent material for emitting light by the excitation by the laser beam irradiation so as to form the low beam light distribution pattern or the high beam light distribution pattern.

As described above, the vehicle light made in accordance with principles of the presently disclosed subject matter can prevent or suppress uneven luminance chromaticity or uneven intensity distribution of light caused by the reflection of blue laser beams emitted from the laser light source and reflected by the surface of the metal plate around the fluorescent material.

Furthermore, the vehicle light made in accordance with the principles of the presently disclosed subject matter can prevent or suppress the occurrence of interfacial peeling caused by the difference of thermal expansion coefficient between the fluorescent material and the member to which the fluorescent material is disposed.

### BRIEF DESCRIPTION OF DRAWINGS

These and other characteristics, features, and advantages of the presently disclosed subject matter will become clear from the following description with reference to the accompanying drawings, wherein:

FIG. 1 is a table comparing the specifications of a fluorescent material (for example, YAG phosphor) excited by a blue laser beam to emit light, a white LED, and an HID lamp;

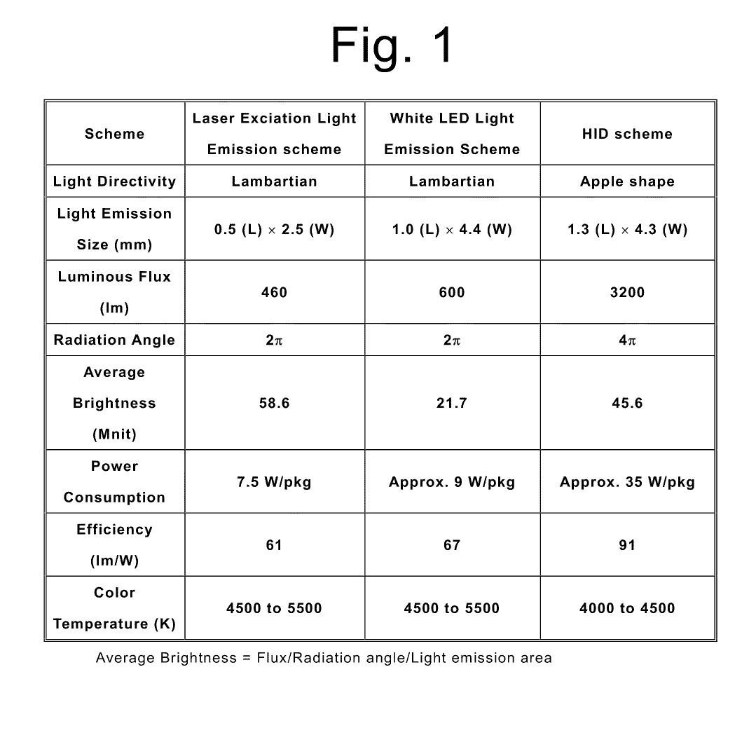

FIG. 2 is a side view illustrating a light source 200 for use in a vehicle light experimentally produced by the present inventors;

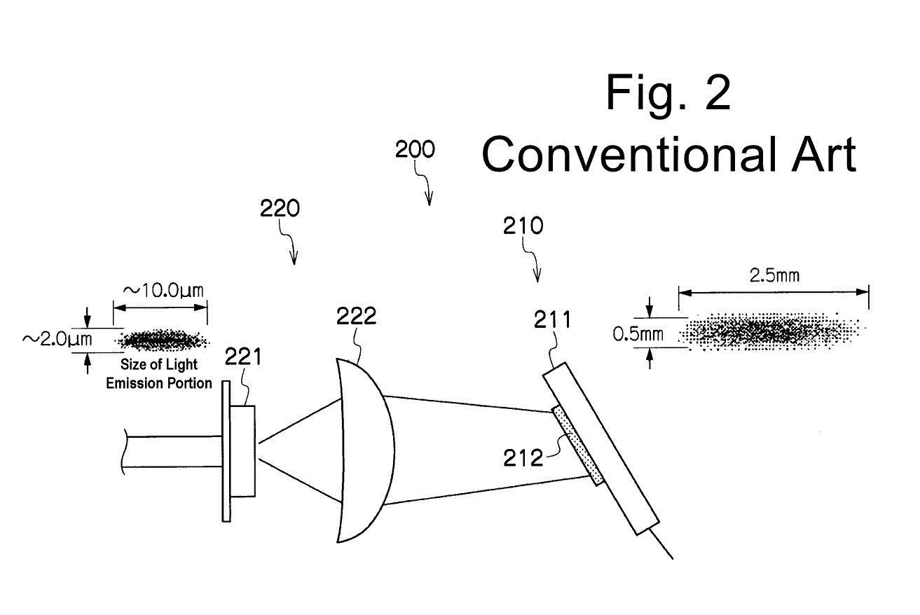

FIG. 3 is a diagram describing a luminous intensity distribution formed by the light from a fluorescent material;

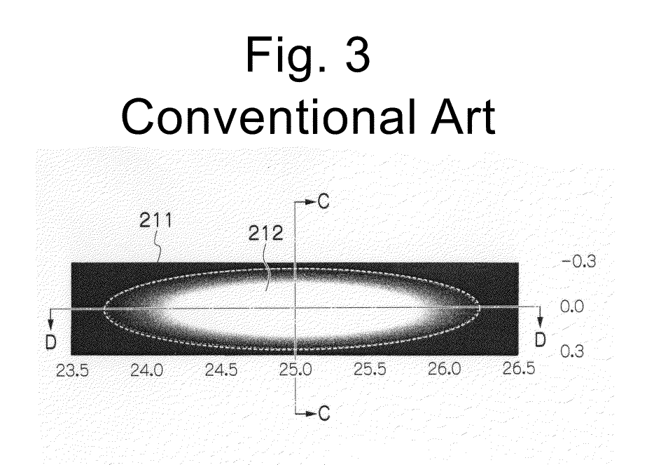

FIG. 4 is a side view illustrating another light source 200 for use in a vehicle light experimentally produced by the present inventors;

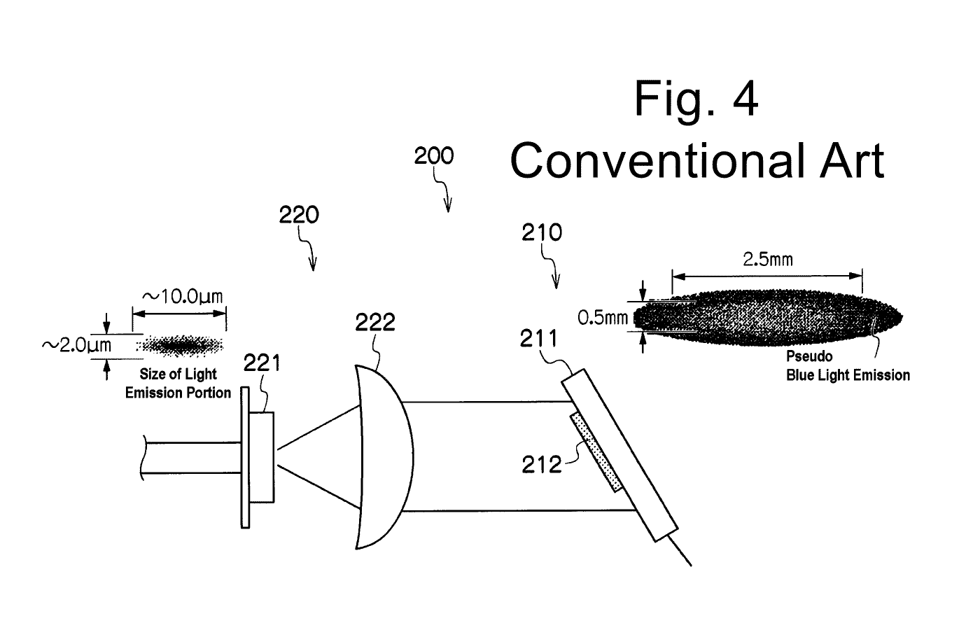

FIG. 5 is a side view illustrating a light emitting portion 210 experimentally produced by the present inventors;

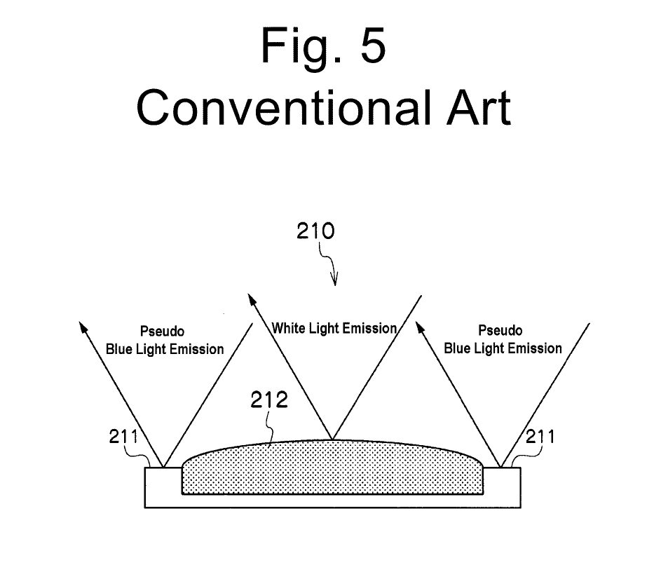

FIGS. 6A and 6B are graphs showing a luminous intensity distribution of an area including the fluorescent material 212 and the metal plate 211 around the material 212 taken along line C-C and line D-D in FIG. 3, respectively;

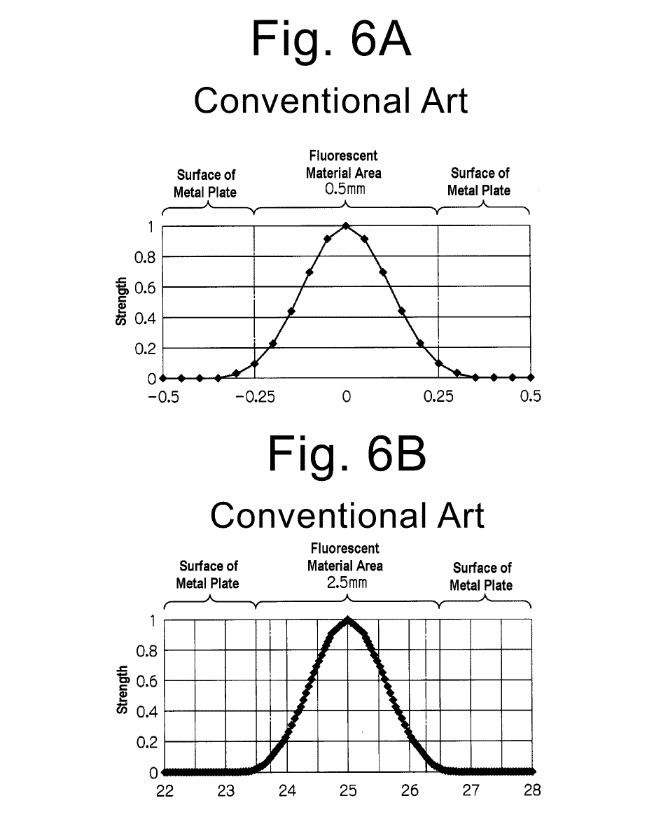

FIG. 7 is a diagram illustrating a light distribution pattern formed by the light source 200 experimentally produced by the present inventors;

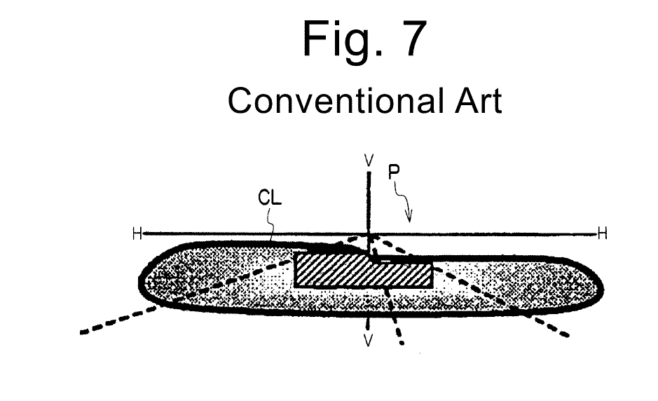

FIG. 8 is a side view illustrating a vehicle light 100 as one exemplary embodiment made in accordance with the principles of the presently disclosed subject matter;

FIG. 9 is a perspective view illustrating the vehicle light 100 of FIG. 8 while a laser optical system is omitted from the drawing;

FIG. 10 is a cross sectional view illustrating a light emitting portion 10 of the vehicle light 100;

FIG. 11 is a front view illustrating a reflection suppressing member 13;

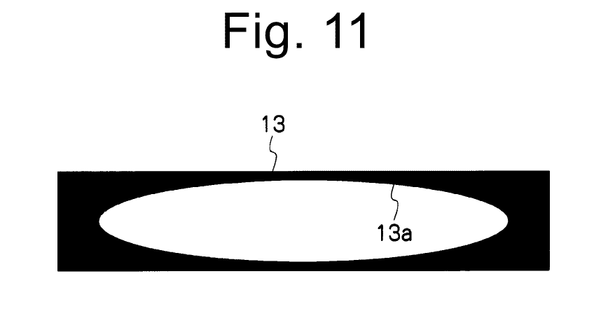

FIG. 12 is a side view illustrating the light emitting portion 10 and the laser optical system 20;

FIG. 13 is a diagram describing a luminous intensity distribution formed by the light from a fluorescent material 12 with the reflection suppressing member 13;

FIGS. 14A and 14B are graphs showing a luminous intensity distribution of an area including the fluorescent material 12 and the reflection suppressing member 13 arranged around the material 12 taken along line A-A and line B-B in FIG. 13, respectively;

FIGS. 15A, 15B, 15C and 15D are perspective views illustrating various configurations of the reflection suppressing member 13;

FIG. 16 is a cross sectional view illustrating a light emitting portion 10 of another exemplary embodiment;

FIG. 17 is a diagram illustrating exemplary manufacturing processes for the light emitting portion;

FIG. 18 is a diagram illustrating the effect of a barium sulfate layer 13 on rear-side reflectance;

FIG. 19 is a cross sectional view illustrating a vehicle light according to a first modified example;

FIG. 20 is a cross sectional view illustrating a vehicle light according to a second modified example; and

FIG. 21 is a diagram illustrating the surface shape of a reflecting surface 51 of the vehicle light according to the second modified example.

### DESCRIPTION OF EXEMPLARY EMBODIMENTS

A description will now be made below to vehicle lights of the presently disclosed subject matter with reference to the accompanying drawings in accordance with exemplary embodiments.

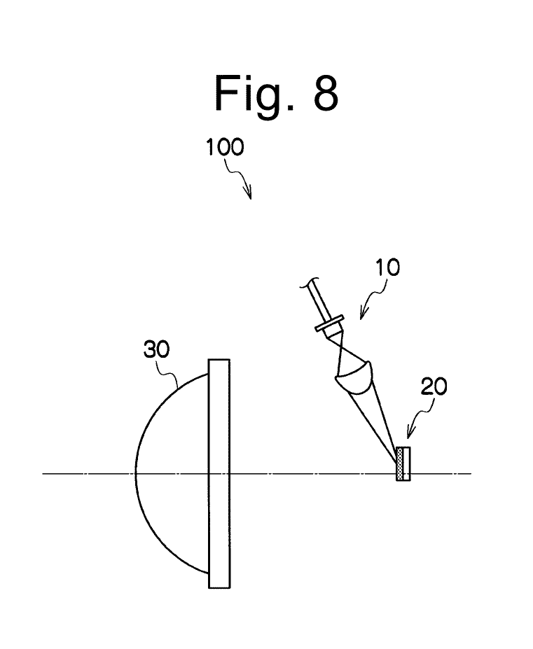

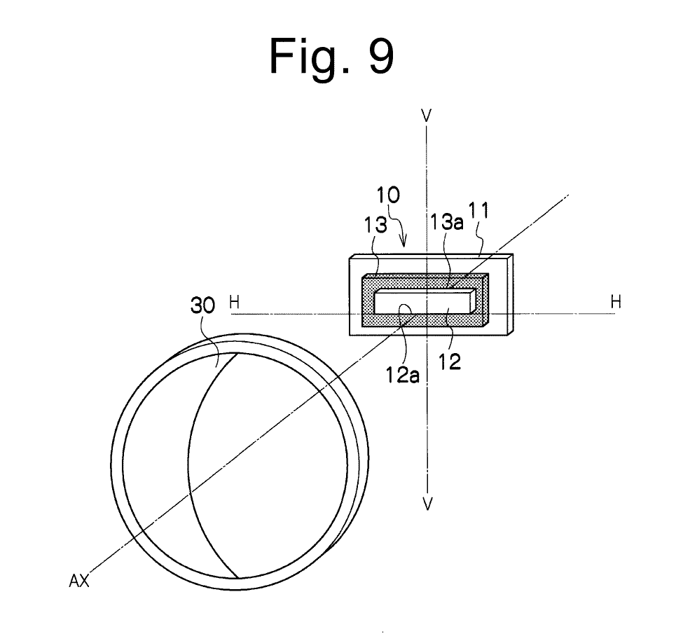

A vehicle light 100 made in accordance with the principles of the presently disclosed subject matter can be incorporated into a headlight, a fog lamp, a signal lamp, or the like for use in an automobile, a motorcycle, truck, other vehicle, boat, traffic signal, or the like. As shown in FIGS. 8 and 9, the vehicle light 100 can include a light emitting portion 10, a laser optical system 20, a projection lens 30, and the like. Hereinafter, descriptions for the respective components will be given.

[Light Emitting Portion 10]

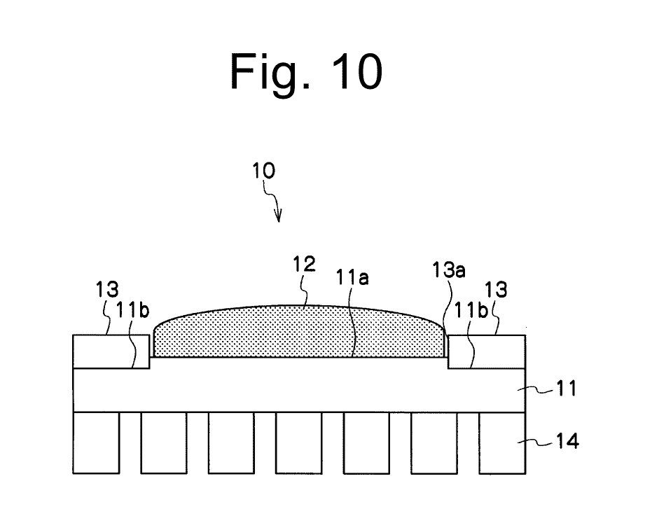

As shown in FIG. 10, the light emitting portion 10 can include a fluorescent material 12, a reflection suppressing member 13, a heat sink 14, and the like.

The metal plate 11 can be, for example, an aluminum plate with the size of 1.5 mm in length, 7.5 mm in width and 2 mm in thickness.

The metal plate 11 can have a surface including a region 11a to which the fluorescent material 12 is applied, and a region 11b on which the reflection suppressing member 13. As shown in FIG. 10, the region 11a to which the fluorescent material 12 is applied may be higher than the region 11b on which the reflection suppressing member 13. When configured as described, it is possible to prevent the reflection suppressing member 13 from blocking white light beams emitted from the fluorescent material 12, thereby improving the light emission efficiency. It should be appreciated that a heat sink 14 for heat dissipation can be fixed on a rear surface of the metal plate 11. The metal plate 11 can be provided with a guiding groove for ensuring positional accuracy for mounting the reflection suppressing member 13 (not shown).

The fluorescent material 12 can be a fluorescent material that can be excited by the irradiation of a blue laser beam to emit light beams, and for example a YAG phosphor. The fluorescent material 12 can be formed by applying the material onto the region 11a of the surface of the metal plate 11 with the size of 0.5 mm in length, 2.5 mm in width, and 0.1 mm in thickness.

The reflection suppressing member 13 can suppress the reflection of blue laser beams emitted from the laser optical system 20 (laser light source 21) and impinging thereon. The reflection suppressing member 13 can be disposed to cover the region 11b of the surface of the metal plate 11 around the fluorescent material 12.

The reflection suppressing member 13 can be formed from a material having an extremely low reflectance. In the present exemplary embodiment, the reflection suppressing member 13 can be formed from a carbon plate having an opening 13a that is horizontally long and is located corresponding to the position where the fluorescent material 12 is disposed. The carbon plate can have a reflectance of 1.5% or less and the size of 0.6 mm in length, 2.7 mm in width, and 0.1 mm in thickness. It should be noted that the material for the reflectance suppressing member 13 can be a carbon nanotube plate.

[Laser Optical System 20]

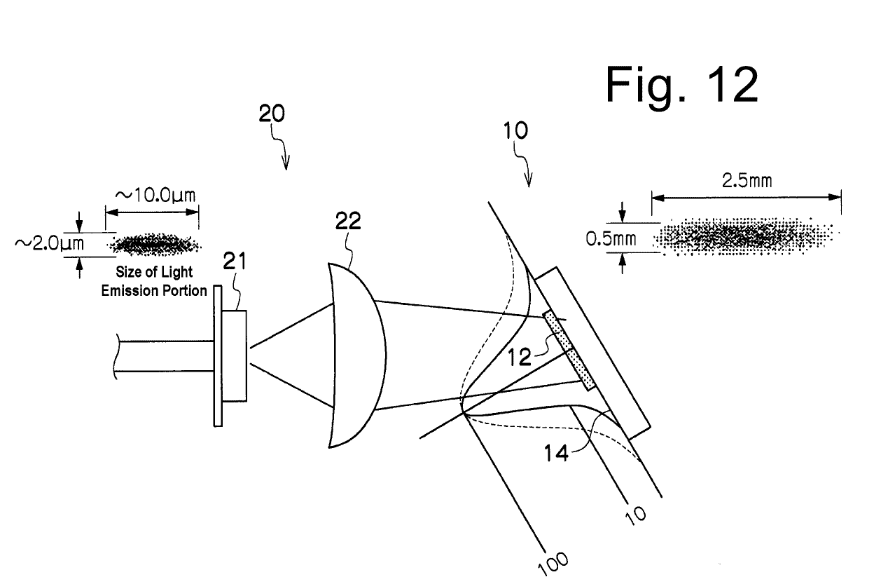

With reference to FIG. 12, the laser optical system 20 can include a laser light source 21 and a lens 22.

The laser light source 21 can be a light source for emitting a blue laser beam (radiation flux) to impinge on the fluorescent material 12. For example, the laser light source 21 can be a high power semiconductor laser device with the following specification:

Light emission size: 2 μM in length and 10 μM in width

Optical output: 2 W

Luminescent chromaticity: blue (440 nm)

Light directivity: Gaussian distribution (30° in a lateral direction and 60° in a longitudinal direction).

The lens 22 can be a lens for converging blue laser beams emitted from the laser light source 21 to be a size almost equal to that of the fluorescent material 12. For example, the lens 22 may be a convergent lens or a collimating lens. The lens 22 can be disposed in front of the laser light source 21.

It should be noted that the size of the laser radiation flux to be converged by the lens 22 can be defined by the range of 10% or greater with respect to the peak value in the Gaussian distribution (see FIG. 12).

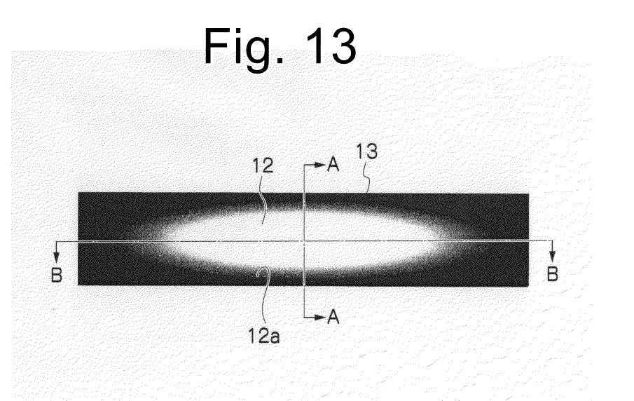

In the above light source 10 as configured above, the blue laser beams emitted from the laser light source 21 can be converged by the action of the lens 22 to have a size equal to the size of the fluorescent material 12 (0.5 mm in length and 2.5 mm in width) and projected onto the fluorescent material 12. The converged laser beams can excite the fluorescent material 12 to cause the fluorescent material 12 to emit light beams thereby generating white light beams through, for example, color addition (see FIG. 13). Herein, the optical characteristic of the light beams may be a Lambertian distribution and the loss ratio with respect to the total amount of incident laser light may be about 8.2%.

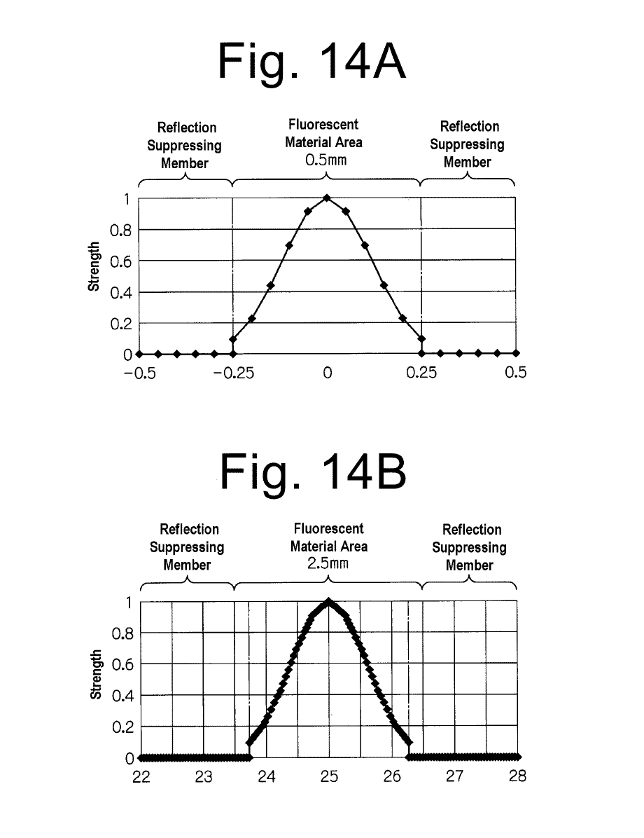

In the light emitting portion 10 and the laser optical system 20 with the above configuration, the reflection suppressing member 13 can cover the region 11b of the surface of the metal plate 11 around the fluorescent material 12 (see FIGS. 9 and 10). Accordingly, even if the size of the radiation flux from the laser optical system 20 becomes larger than the size of the fluorescent material 12 for some reason (or the blue laser beams from the laser optical system 20 are shifted with respect to the fluorescent material 12), the blue laser beams larger in size (or shifted) can impinge not on the region 11b of the surface of the metal plate 11 around the fluorescent material 12 but on the reflection suppressing member 13 thereby suppressing the reflection therefrom (see FIGS. 14A and 14B). It should be noted that FIGS. 14A and 14B are graphs showing a luminous intensity distribution of an area including the fluorescent material 12 and the reflection suppressing member 13 arranged around the material 12 taken along line A-A and line B-B in FIG. 13, respectively. In this configuration, the energy ratio of blue laser beams reflected by the reflection suppressing member 13 can be reduced to 1.2%. Therefore, the vehicle light 100 with this configuration can prevent or suppress the uneven luminance chromaticity or uneven intensity distribution of light caused by the reflection of blue laser beams emitted from the laser light source 21 and reflected by the region 11b of the surface of the metal plate 11 around the fluorescent material 12.

[Projection Lens 30]

The projection lens 30 can be disposed in front of the fluorescent material 20 as shown in FIGS. 8 and 9 so that its focus can be disposed at or near a side 12a of the fluorescent material 12 corresponding to a bright/dark boundary line.

The vehicle light 100 with the above configuration can project the image of the fluorescent material 12 excited by the blue laser beams and emitting light through the projector lens 30. As a result, according to the presently disclosed subject matter, a so-called direct projection type vehicle light can be configured to form a high beam light distribution pattern without (or almost without) uneven luminance chromaticity or uneven intensity distribution.

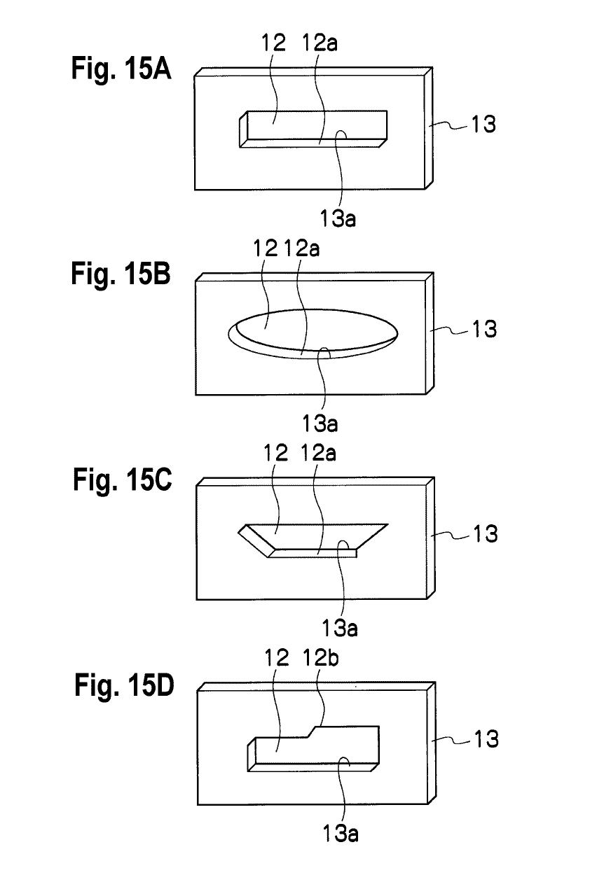

In a modified example, the reflection suppressing member 13 can be formed from a carbon plate with an opening 13a with a stepped side 12b corresponding to the bright/dark boundary line in the light distribution pattern, as shown in FIG. 15D. As in the previous case, this configuration can provide a so-called direct projection type vehicle light to form a low beam light distribution pattern including a clear bright/dark boundary line without (or almost without) uneven luminance chromaticity or uneven intensity distribution.

Next, a description will be given of a vehicle light of another exemplary embodiment made in accordance with the principles of the presently disclosed subject matter with reference to the accompanying drawings.

A vehicle light 100 of the present exemplary embodiment made in accordance with principles of the presently disclosed subject matter can be applied to a headlight, a fog lamp, a signal lamp, or the like for use in an automobile, a motorcycle, other vehicle, or the like as in the previous exemplary embodiment. As shown in FIGS. 8 and 9, the vehicle light 100 can include a light emitting portion 10, a laser optical system 20, a projection lens 30, and the like. Hereinafter, description for the same or similar components as in the previous exemplary embodiment will be omitted appropriately.

[Light Emitting Portion 10]

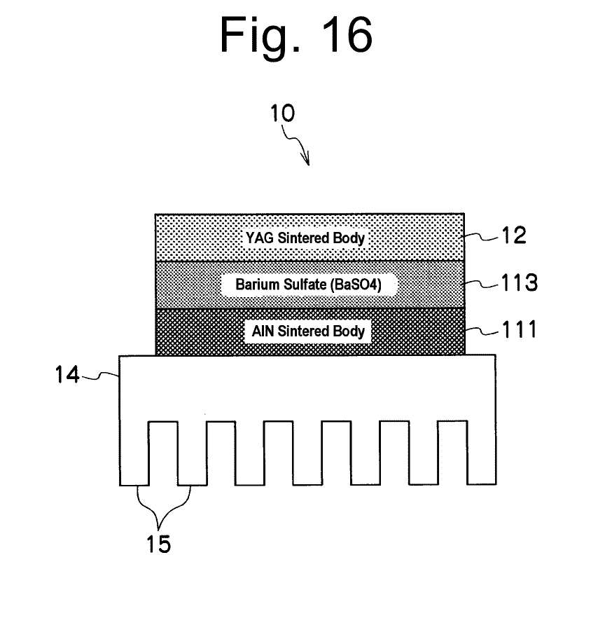

As shown in FIG. 16, the light emitting portion 10 can be a structure including an AlN sintered body 111, a fluorescent material 12, and a barium sulfate layer 113 formed between the AlN sintered body 111 and the fluorescent material 12. In addition to the AlN sintered body 111, the mating member to be used together with the fluorescent material 12 can include an SiC single crystal, an SiC polycrystal, an SiC amorphous material, Al₂O₃ ceramics, Si, a sapphire single crystal, a GaN single crystal, or the like. The structure can be eutectic bonded to a heat dissipation plate 14 made of Al on the side of the AlN sintered body 111. Examples other than the Al heat dissipation plate 14 can include, as the heat dissipation member, Cu, CuW, SiC amorphous and the like material having a heat conductivity of 100 W/(m·K) or more. It should be appreciated that an Al heat sink 15 for heat dissipation can be fixed on a rear surface of the Al heat dissipation plate 11.

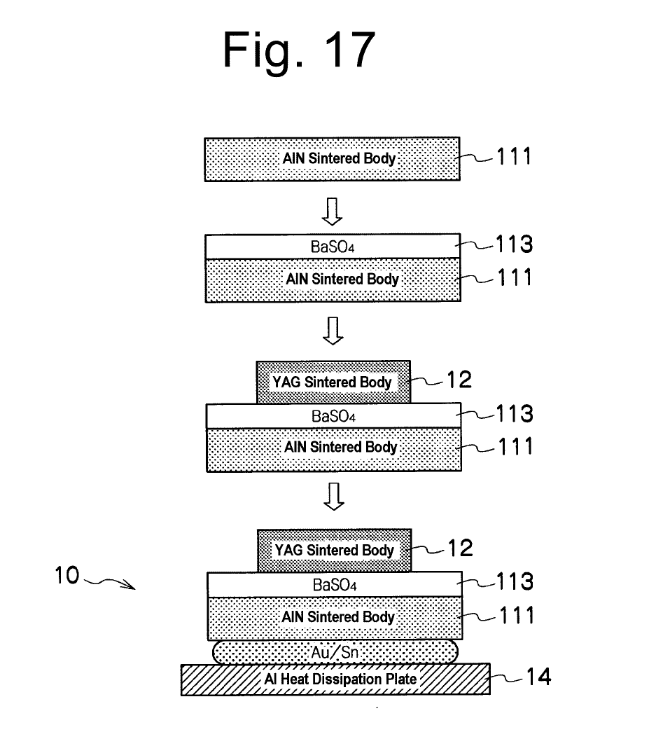

The light emitting portion 10 can be produced by the processes illustrated in FIG. 17, for example.

First, a barium sulfate powder (BaSO₄, thermal expansion coefficient: 4 to 6) is added to water or a binder (for example, epoxy resin, an organic SOG (Spin-On Glass) material, and the like) to form a gel. The mixing ratio between the barium sulfate and water (binder) can be determined according to a target film thickness, and an example of the mixing ratio is BaSO₄:H₂O=3:1 to 1:1 by weight.

Then, the barium sulfate gel is coated on an AlN sintered body 111, for example, a thin-plate AlN sintered body 111 with a thickness of 100 to 300 μm and a thermal expansion coefficient of 4.5. Next, a fluorescent material 12 (for example, a thin-plate YAG sintered body with a thickness of 100 μM and a thermal expansion coefficient of 2.4 to 7.8) is placed on the AlN sintered body 111 with the barium sulfate layer (serving as a bonding layer) coated thereon. The prepared structure is subjected to an evaporation process under the conditions of 90° C. for 30 min. to evaporate the contained water. Then, a high temperature processing is performed under the condition of 400° C. for 30 min.

By carrying out these processes, the integral structure can be obtained in which the AlN sintered body 111, the fluorescent material 12, and the barium sulfate layer 113 formed between the AlN sintered body 111 and the fluorescent material 12 are layered.

The above structure is placed on an Al heat dissipation plate 14 through an Au_{0.2}Sn_{0.6} paste (heat conductivity: approx. 120 W/m·K, thermal expansion coefficient: 2.1×10⁻⁵) at the side of the AlN sintered body 111. It should be noted that examples of the paste may include, in addition to the Au_{0.2}Sn_{0.6} paste an Au_{0.78}Sn_{0.23} paste (heat conductivity: approx. 260 W/m·K, thermal expansion coefficient: 1.6×10⁻⁵, eutectic temperature: 320° C.), an Ag paste (cured temperature: 130° C., heat conductivity: approx. 5 to 60 W/m·K, thermal expansion coefficient: 2.5 to 9.0×10⁻⁵), and the like. The use of the Au_{0.78}Sn_{0.23} paste can increase the bonding strength and the heat conductivity because of the high eutectic temperature.

Then, the light emitting portion 10 is completed by eutectic bonding the structure at the side of the AlN sintered body 111 with the Al heat dissipation plate 14 serving as the heat dissipation member.

[Laser Optical System 20]

With reference to FIG. 12, the laser optical system 20 can include a laser light source 21 and a lens 22. The basic configuration of the laser optical system 20 can be the same as in the previous exemplary embodiment and therefore, a detailed description therefore will be omitted here. It should be noted that a UV laser light source, an excitation light source utilizing a semiconductor diode laser and the like can be utilized in addition to the blue laser light source as the laser light source 21.

In the light emitting portion 10 and the laser optical system 20 of the present exemplary embodiment with the above configuration, the barium sulfate layer 113 formed between the AlN sintered body 111 and the fluorescent material 12 can exert its buffer action, and it is possible to prevent or suppress the occurrence of interfacial peeling caused by the difference of thermal expansion coefficient between the AlN sintered body 111 and the fluorescent material 12. An experiment performed by the present inventors revealed that the durability of the light emitting portion 10 could be increased several tens times when compared with the structure only containing the AlN sintered body 111 and the fluorescent material 12 (namely without the barium sulfate layer 113).

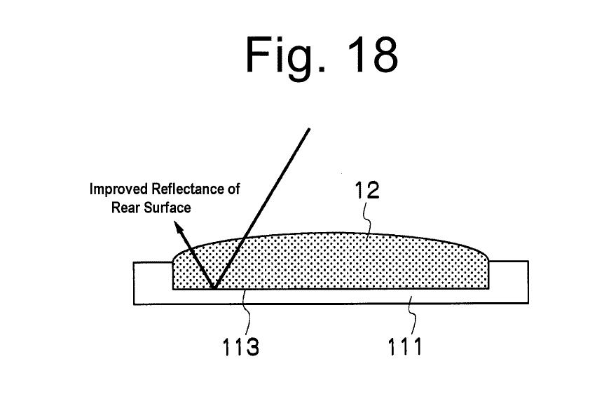

In addition to the above advantageous effect, as the barium sulfate layer 113 has a high reflectance closer to 100% (higher than aluminum), it is possible to increase the light emission efficiency from the laser optical system (see FIG. 18). According to an experiment performed by the present inventors, the barium sulfate layer 113 could provide the light emission efficiency (or light utilization efficiency) of approx. 100% whereas aluminum could provide the light emission efficiency (or light utilization efficiency) of 92%, meaning the present exemplary embodiment could improve it by 8%, in a particular example.

It should be noted that a reflection suppressing member 13 (see FIG. 9) can be disposed on an area of the metal plate surface (or Al heat dissipation plate 14) around the structure (the integrated structure including the AlN sintered body 111, the fluorescent material 12, and the barium sulfate layer 113 formed between the AlN sintered body 111 and the fluorescent material 12, see FIG. 16). Accordingly, even if the size of the radiation flux from the laser optical system 20 becomes larger than the size of the fluorescent material 12 for some reason (or the blue laser beams from the laser optical system 20 are shifted with respect to the fluorescent material 12), the blue laser beams larger in size (or shifted) can impinge not on the region of the surface of the Al heat dissipation plate 14 around the fluorescent material 12 but on the reflection suppressing member 13 thereby suppressing the reflection therefrom. Therefore, the vehicle light 100 with this configuration can prevent or suppress the uneven luminance chromaticity or uneven intensity distribution of light caused by the reflection of blue laser beams emitted from the laser light source 21 and reflected by the region of the surface of the Al heat dissipation plate 14 around the fluorescent material 12. The reflection suppressing member 13 can be formed from a material having an extremely low reflectance, and examples of the material therefore include a carbon plate having an opening 13a that is horizontally long and is located corresponding to the position where the fluorescent material 12 is disposed (see FIG. 15, reflectance of 1.5% or less), a carbon nanotube plate, and the like.

The projector lens, the reflection suppressing member 13, and the like can be configured as in the previous exemplary embodiment, and accordingly, the descriptions therefore will be omitted here.

According to the vehicle light 100 with the above configuration, the barium sulfate layer 113 formed between the AlN sintered body 111 and the fluorescent material 12 can exert its buffer action, and it is possible to prevent or suppress the occurrence of interfacial peeling caused by the difference of thermal expansion coefficient between the AlN sintered body 111 and the fluorescent material 12.

Next, several modified examples will be described.

### Modified Example 1

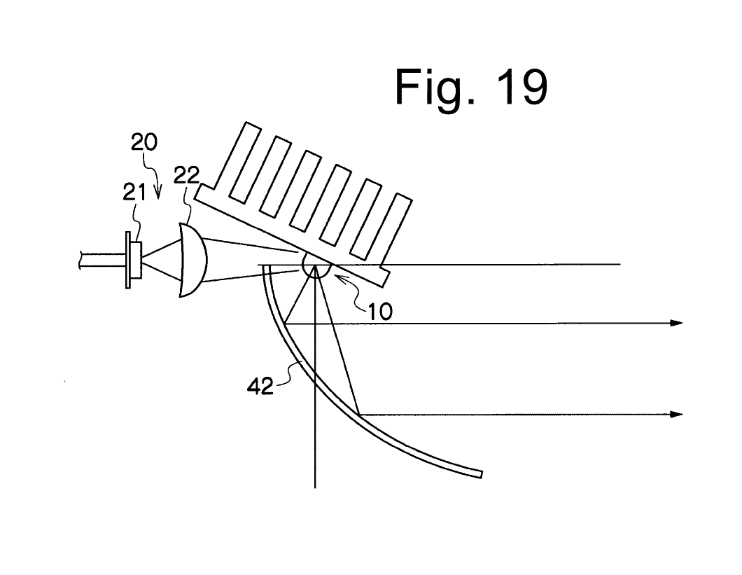

The vehicle light 100 in accordance with a modified example 1 can include, as shown in FIG. 19, the light emitting portion 10, the laser optical system 20, and a reflecting surface 40, and the like.

The reflecting surface 40 can be a revolved parabolic reflecting surface having a focus disposed at or near (i.e., substantially at) the side 12a of the fluorescent material 12 that corresponds to the bright/dark boundary line in the light distribution pattern.

According to the present modified example 1, the reflection suppressing member 13 can be a carbon plate shown in FIG. 15B, for example, having a horizontally long elliptic opening 13a where the fluorescent material 12 can be disposed. This configuration can provide a reflective type (or parabola type) vehicle light that can form a high beam light distribution pattern without (or almost without) uneven luminance chromaticity or uneven intensity distribution of light.

Alternatively, the reflection suppressing member 13 can be a carbon plate shown in FIG. 15A or 15C, for example, having an opening 13a where the fluorescent material 12 having a side 12a corresponding to a bright/dark boundary line in the light distribution pattern can be disposed. This configuration can provide a reflective type (or parabola type) vehicle light that can form a low beam light distribution pattern including the clear bright/dark boundary line without (or almost without) uneven luminance chromaticity or uneven intensity distribution of light.

### Modified Example 2

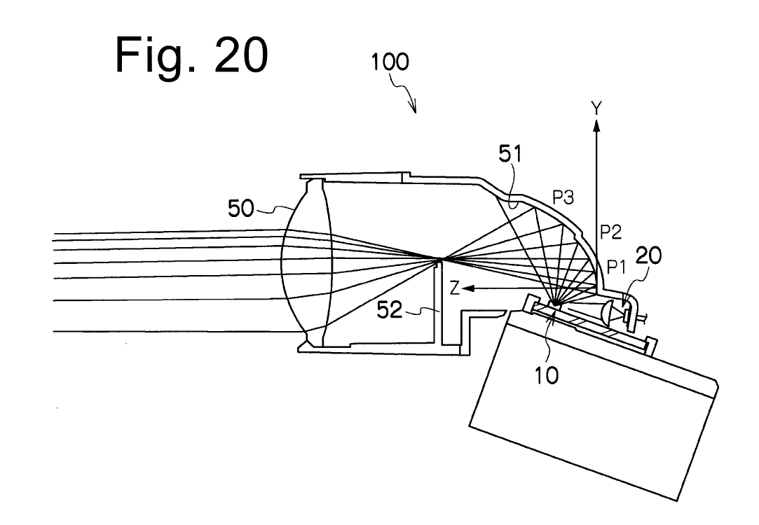

The vehicle light 100 in accordance with the modified example 2 can include, as shown in FIG. 20, the light emitting portion 10, the laser optical system 20, the projector lens 50, a reflecting surface 51, a light shielding member 52 disposed between the projector lens 50 and the reflecting surface 51, and the like.

The projector lens 50 can have a focus disposed at or near the upper edge of the light-shielding member 52.

The reflecting surface 51 can be a revolved elliptic reflecting surface having a first focus disposed at or near the side 12a of the fluorescent material 12 corresponding to the bright/dark boundary and a second focus disposed at or near the upper edge of the light-shielding member 52. In the elliptic reflecting surface, a parabola appears in a longitudinal cross section and a part of a ellipsoid appears in a horizontal cross section.

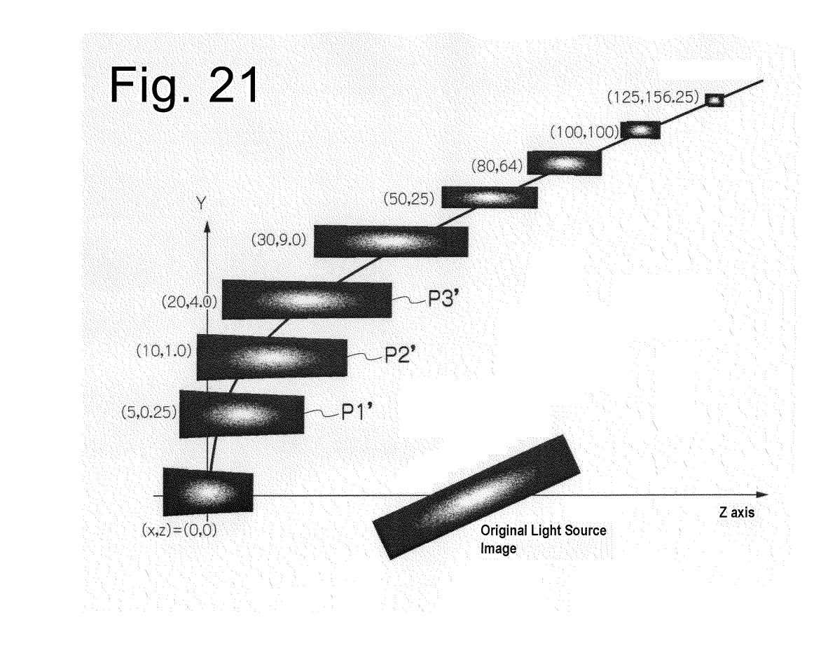

For example, the reflecting surface 51 can be configured such that the image of the fluorescent material 12 at respective points P1, P2, P3, and the like on the Y-Z coordinate system in FIG. 20 can be the images P1′, P2′, P3′, and the like in FIG. 21 at respective Y-Z coordinates.

According to the present modified example 2, the reflection suppressing member 13 can be a carbon plate shown in FIG. 15B, for example, having a horizontally long elliptic opening 13a where the fluorescent material 12 can be disposed. This configuration can provide a projector type vehicle light that can form a high beam light distribution pattern without (or almost without) uneven luminance chromaticity or uneven intensity distribution of light.

Alternatively, the reflection suppressing member 13 can be a carbon plate shown in FIG. 15A or 15C, for example, having an opening 13a where the fluorescent material 12 having a side 12a corresponding to a bright/dark boundary line in the light distribution pattern can be disposed. This configuration can provide a projector type vehicle light that can form a low beam light distribution pattern including the clear bright/dark boundary line without (or almost without) uneven luminance chromaticity or uneven intensity distribution of light.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle light comprising:
a metal plate;
a fluorescent material located on a surface of the metal plate and configured to serve as a light source for emitting light beams as a result of excitation by a blue laser beam;
a laser light source configured to emit the blue laser beam incident on the fluorescent material; and
a reflection suppressing member configured to cover a surface of the metal plate located around the fluorescent material and configured to suppress reflection of the blue laser beam emitted by the laser light source.

2. The vehicle light according to claim 1, wherein the reflection suppressing member is formed from a carbon plate having an opening where the fluorescent material is to be disposed.

3. The vehicle light according to claim 1, further comprising an optical system configured to project an image of the fluorescent material as a light source image so as to form one of a low beam light distribution pattern and a high beam light distribution pattern.

4. The vehicle light according to claim 2, further comprising an optical system configured to project an image of the fluorescent material as a light source image so as to form one of a low beam light distribution pattern and a high beam light distribution pattern.

5. The vehicle light according to claim 3, wherein:
the fluorescent material is configured to include a side corresponding to one of a bright/dark boundary line of the low beam light distribution pattern and the high beam light distribution pattern; and
the optical system comprises a projection lens having a focus disposed at or near the side of the fluorescent material corresponding to the bright/dark boundary line, and is disposed in front of the fluorescent material.

6. The vehicle light according to claim 4, wherein:
the fluorescent material is configured to include a side corresponding to one of a bright/dark boundary line of the low beam light distribution pattern and the high beam light distribution pattern; and
the optical system comprises a projection lens having a focus disposed at or near the side of the fluorescent material corresponding to the bright/dark boundary line, and is disposed in front of the fluorescent material.

7. The vehicle light according to claim 3, wherein:
the fluorescent material is configured to include a side corresponding to one of a bright/dark boundary line of the low beam light distribution pattern and the high beam light distribution pattern;
the optical system comprises a projection lens, a reflecting surface, and a light-shielding member disposed between the projection lens and the reflecting surface and having an upper edge;
the reflecting surface is a revolved elliptic reflecting surface having a first focus disposed at or near the side of the fluorescent material corresponding to the bright/dark boundary and a second focus disposed at or near the upper edge of the light-shielding member; and
the projection lens has a focus disposed at or near the upper edge of the light-shielding member.

8. The vehicle light according to claim 4, wherein:
the fluorescent material is configured to include a side corresponding to one of a bright/dark boundary line of the low beam light distribution pattern and the high beam light distribution pattern;
the optical system comprises a projection lens, a reflecting surface, and a light-shielding member disposed between the projection lens and the reflecting surface and having an upper edge;
the reflecting surface is a revolved elliptic reflecting surface having a first focus disposed at or near the side of the fluorescent material corresponding to the bright/dark boundary and a second focus disposed at or near the upper edge of the light-shielding member; and
the projection lens has a focus disposed at or near the upper edge of the light-shielding member.

9. The vehicle light according to claim 3, wherein:
the fluorescent material is configured to include a side corresponding to one of a bright/dark boundary line of the low beam light distribution pattern and the high beam light distribution pattern; and
the optical system comprises a revolved parabolic reflecting surface having a focus disposed at or near the side of the fluorescent material corresponding to the bright/dark boundary line.

10. The vehicle light according to claim 4, wherein:
the fluorescent material is configured to include a side corresponding to one of a bright/dark boundary line of the low beam light distribution pattern and the high beam light distribution pattern; and
the optical system comprises a revolved parabolic reflecting surface having a focus disposed at or near the side of the fluorescent material corresponding to the bright/dark boundary line.

11. A vehicle light comprising:
a structure including a fluorescent material configured to serve as a light source emitting light beams as a result of excitation by a laser beam, a mating member having a different thermal expansion coefficient from a thermal expansion coefficient of the fluorescent material, and a barium sulfate layer located between the fluorescent material and the mating member; and
a laser light source configured to emit the laser beam to be incident on the fluorescent material.

12. The vehicle light according to claim 11, wherein the mating member is formed from an AlN sintered body.

13. The vehicle light according to claim 12, further comprising a heat dissipation member, and wherein
the AlN sintered body is eutectic bonded to the heat dissipation member.

14. The vehicle light according to claim 11, further comprising an optical system configured to project an image of the fluorescent material as a light source image so as to form one of a low beam light distribution pattern and a high beam light distribution pattern.

15. The vehicle light according to claim 12, further comprising an optical system configured to project an image of the fluorescent material as a light source image so as to form one of a low beam light distribution pattern and a high beam light distribution pattern.

16. The vehicle light according to claim 13, further comprising an optical system configured to project an image of the fluorescent material as a light source image so as to form one of a low beam light distribution pattern and a high beam light distribution pattern.

17. The vehicle light according to claim 14, wherein:
the fluorescent material is configured to include a side corresponding to one of a bright/dark boundary line of the low beam light distribution pattern and the high beam light distribution pattern; and
the optical system comprises a projection lens having a focus disposed substantially at the side of the fluorescent material corresponding to the bright/dark boundary line, and is disposed in front of the fluorescent material.

18. The vehicle light according to claim 15, wherein:
the fluorescent material is configured to include a side corresponding to one of a bright/dark boundary line of the low beam light distribution pattern and the high beam light distribution pattern; and
the optical system comprises a projection lens having a focus disposed substantially at the side of the fluorescent material corresponding to the bright/dark boundary line, and is disposed in front of the fluorescent material.

19. The vehicle light according to claim 16, wherein:
the fluorescent material is configured to include a side corresponding to one of a bright/dark boundary line of the low beam light distribution pattern and the high beam light distribution pattern; and
the optical system comprises a projection lens having a focus disposed substantially at the side of the fluorescent material corresponding to the bright/dark boundary line, and is disposed in front of the fluorescent material.

20. The vehicle light according to claim 14, wherein:
the fluorescent material is configured to include a side corresponding to one of a bright/dark boundary line of the low beam light distribution pattern and the high beam light distribution pattern;
the optical system comprises a projection lens, a reflecting surface, and a light-shielding member disposed between the projection lens and the reflecting surface and having an upper edge;
the reflecting surface is a revolved elliptic reflecting surface having a first focus disposed substantially at the side of the fluorescent material corresponding to the bright/dark boundary and a second focus disposed substantially at the upper edge of the light-shielding member; and
the projection lens has a focus disposed substantially at the upper edge of the light-shielding member.

21. The vehicle light according to claim 15, wherein:
the fluorescent material is configured to include a side corresponding to one of a bright/dark boundary line of the low beam light distribution pattern and the high beam light distribution pattern;
the optical system comprises a projection lens, a reflecting surface, and a light-shielding member disposed between the projection lens and the reflecting surface and having an upper edge;
the reflecting surface is a revolved elliptic reflecting surface having a first focus disposed substantially at the side of the fluorescent material corresponding to the bright/dark boundary and a second focus disposed substantially at the upper edge of the light-shielding member; and
the projection lens has a focus disposed substantially at the upper edge of the light-shielding member.

22. The vehicle light according to claim 16, wherein:
the fluorescent material is configured to include a side corresponding to one of a bright/dark boundary line of the low beam light distribution pattern and the high beam light distribution pattern;
the optical system comprises a projection lens, a reflecting surface, and a light-shielding member disposed between the projection lens and the reflecting surface and having an upper edge;
the reflecting surface is a revolved elliptic reflecting surface having a first focus disposed substantially at the side of the fluorescent material corresponding to the bright/dark boundary and a second focus disposed substantially at the upper edge of the light-shielding member; and
the projection lens has a focus disposed substantially at the upper edge of the light-shielding member.

23. The vehicle light according to claim 14, wherein:
the fluorescent material is configured to include a side corresponding to one of a bright/dark boundary line of the low beam light distribution pattern and the high beam light distribution pattern; and
the optical system comprises a revolved parabolic reflecting surface having a focus disposed substantially at the side of the fluorescent material corresponding to the bright/dark boundary line.

24. The vehicle light according to claim 15, wherein:
the fluorescent material is configured to include a side corresponding to one of a bright/dark boundary line of the low beam light distribution pattern and the high beam light distribution pattern; and
the optical system comprises a revolved parabolic reflecting surface having a focus disposed substantially at the side of the fluorescent material corresponding to the bright/dark boundary line.

25. The vehicle light according to claim 16, wherein:
the fluorescent material is configured to include a side corresponding to one of a bright/dark boundary line of the low beam light distribution pattern and the high beam light distribution pattern; and
the optical system comprises a revolved parabolic reflecting surface having a focus disposed substantially at the side of the fluorescent material corresponding to the bright/dark boundary line.
